(19) United States
(12) Patent Application Publication
(10) Pub. No.: US 2015/0142334 A1
(43) Pub. Date: May 21, 2015

(54) SYSTEM, METHOD AND COMPUTER-ACCESSIBLE MEDIUM FOR GENETIC BASE CALLING AND MAPPING

(71) Applicant: NEW YORK UNIVERSITY, NEW YORK, NY (US)

(72) Inventor: BHUBANESWAR MISHRA, Great Neck, NY (US)

(21) Appl. No.: 14/543,016

(22) Filed: Nov. 17, 2014

Related U.S. Application Data
(60) Provisional application No. 61/904,779, filed on Nov. 15, 2013.

(51) Int. Cl. G06F 19/24; G06F 19/18

(52) U.S. Cl. CPC G06F 19/24; G06F 19/18
USPC 702/20

(57) ABSTRACT

RNA sequencing techniques provide rapid base-calling and resequencing for improved bio-informatics. Exemplary embodiments of computer-implemented systems and methods can be provided, as applied to RNA sequence interpretation, enumeration and classification, etc., by defining a map of the transcripts encoded in a genome, and measuring their relative abundances

### CROSS-REFERENCE TO RELATED APPLICATION(S)

This application relates to and claims priority from U.S. Patent Application No. 61/904,779, filed on Nov. 15, 2013, the entire disclosure of which is incorporated herein by reference.

### FIELD OF THE DISCLOSURE

Exemplary embodiments of the present disclosure relate generally to genetic sequencing, and specifically to base-calling and genetic mapping, including but not limited, for example, to defining a map of the transcripts encoded in a genome, and measuring their relative abundances.

### BACKGROUND INFORMATION

Understanding complex mammalian biology depends on the ability to define a precise map of all the transcripts encoded in a genome, and to measure their relative abundances. A promising assay can depend on RNASeq approaches, which builds on next generation sequencing pipelines capable of interrogating cDNAs extracted from a cell. The underlying pipeline starts with base-calling, collecting the sequence reads and interpreting the raw-read in terms of transcripts that can be grouped with respect to different splice-variant isoforms of a messenger RNA.

A basic problem involved in these pipelines exists which can include, for example, accurate Bayesian base-calling, which could combine the analog intensity data with suitable underlying priors on base-composition in the transcripts. In context of sequencing genomic DNA, a powerful approach for base-calling has been developed in the TotalReCaller pipeline. It uses a suitable reference whole-genome sequence in a compressed self-indexed format to derive its priors. However, TotalReCaller faces certain challenges in the transcriptomic domain, especially since a fully annotated library of all possible transcripts can be lacking, as well as sufficiently good prior.

There can be a number of possible solutions, similar to the ones developed for TotalReCaller, in applications addressing de novo sequencing and assembly, where partial contigs or string-graphs could be used to boot-strap the Bayesian priors on base-composition. A similar approach would be applicable here too, and partial assembly of transcripts can be used to characterize the splicing junctions or organize them in incompatibility graphs and then used as priors for TotalReCaller.

Procedural techniques for this purpose can be addressed in Stringomics. For example, a related but fundamental problem can be addressed, by assuming that there is only a reference genome, with certain intervals marked as candidate regions for Open Reading Frames (“ORF”), but not necessarily complete annotations regarding the 5′ or 3′ termini of a gene or its exon-intron structure.

To obtain key insights into biological problems, especially those with important biomedical implications, it can be preferable to observe how a population of cells of heterogeneous types behaves over time. By identifying and quantifying the full set of transcripts in a small number of cells at different timepoints, and under different conditions, and further aided by sophisticated systems-biology inference tools, there have been attempts to fill in the gaps in the understanding of complex biological processes (e.g., those involved in disease progression). For example, previous work has discussed the hurdles posed by both the heterogeneity and temporality in cancer as detected by single cell genomic assays that could be easily carried over different stages of cancer progression. (See, e.g., Reference 25).

A complex picture has emerged from these studies. Namely, that a tumor can be a highly heterogeneous mixture of many different cell-types, and that each cell can assume different cell-state in response to the micro-environment, signaling metabolic needs with different strategies in different cell-types. Thus an important problem faced by the cancer biotechnologists can be that of collecting and interpreting massive amount of transcriptomic data just from a single patient assuming that in the near future assessing both DNA and RNA content simultaneously from hundreds to thousands of single cells will be quantitatively accurate, as complete as needed, and affordable.

Thus, it may be beneficial to provide an exemplary system, method and computer-accessible medium for genetic base calling and mapping, which can overcome at least some of the deficiencies described herein above.

### SUMMARY OF EXEMPLARY EMBODIMENTS

An exemplary system, method and computer-accessible medium can be provided for generating a transcriptome profile(s) and a transcriptome assembly(s) of a patient(s), which can include, for example, receiving first information related to an analog output from a sequencing platform configured to be used for reading a fragment of at least one transcriptome, generating second information related to a base calling of the first information, and generating the transcriptome profile(s) and the transcriptome assembly(s) based on the second information. The base calling can include (i) a base calling without reference, (ii) a base calling with a gappy alignment to a reference genome, or (iii) a base calling with alignment to an annotated reference transcriptome. The second information can be generated without knowledge of whether a complimentary deoxyribonucleic acid(s) (cDNA) can correspond to (i) an annotated gene(s), (ii) an unannotated gene(s), (iii) a pseudo gene(s), or (iv) a contaminant(s).

In some exemplary embodiments of the present disclosure, third information related to whether a complimentary deoxyribonucleic acid(s) (cDNA) is an annotated or an unannotated gene can be determined using, for example multiple branch-and-bound procedures, which can be performed by the computer arrangement substantially in parallel with one another. Each brand-and-bound procedure of the branch-and-bound procedures can be configured to call bases with at least two sets of priors. A dictionary of a plurality of unannotated genes including (i) isoforms of genes, (ii) isoform of pseudo-genes, (iii) structural descriptions of exons, (iv) structural descriptions of introns, or (v) splicing junctions can be generated. Contaminants can be filtered from the dictionary.

In certain exemplary embodiments of the present disclosure, the transcriptome profile(s) can be generated based on a Bayesian procedure, which can model a distribution of data corresponding to a particular hypothesized transcriptome profile. The transcriptome assembly includes at least one of (i) mutational changes to transcripts, (ii) transcript editing, (iii) new transcripts, (iv) new splice-variant isoforms of known and unknown transcripts, or (v) sterile transcripts. The transcriptome assembly(s) can be based on pseudo-gene(s).

In some exemplary embodiments of the present disclosure, the transcriptome assembly(s) can be generated based on an overlap-layout-consensus-based global-optimizing procedure, which can be configured to assemble reads. The overlap-layout-consensus-based global-optimizing procedure can configure the computer arrangement to determine particular assemblies that (i) fail to match known annotated transcripts, or (ii) fail to align to a reference by a gappy alignment. Third information related to a patient(s) can be generated based on the transcriptome profile(s) and the transcriptome assembly(s). The third information can include (i) a disease of the patient(s), (ii) a disease state of a disease of the patient(s), or (iii) a therapy to be applied to the patient(s).

These and other objects, features and advantages of the exemplary embodiments of the present disclosure will become apparent upon reading the following detailed description of the exemplary embodiments of the present disclosure, when taken in conjunction with the appended claims.

### BRIEF DESCRIPTION OF THE DRAWINGS

The foregoing and other objects of the present disclosure will be apparent upon consideration of the following detailed description, taken in conjunction with the accompanying exemplary drawings and claims showing illustrative embodiments of the present disclosure, in which:

FIG. 1 is an exemplary block diagram of an exemplary system in accordance with an exemplary embodiment of the present disclosure;

FIG. 2 is an exemplary block diagram of an exemplary method in accordance with an exemplary embodiment of the present disclosure; and

FIG. 3 is an exemplary block diagram of a further exemplary method in accordance with an exemplary embodiment of the present disclosure

Throughout the drawings, the same reference numerals and characters, unless otherwise stated, are used to denote like features, elements, components or portions of the illustrated embodiments. Moreover, while the present disclosure will now be described in detail with reference to the figures, it is done so in connection with the illustrative embodiments and is not limited by the particular embodiments illustrated in the figures or provided in the appended claims.

### DETAILED DESCRIPTION OF EXEMPLARY EMBODIMENTS

### Exemplary Challenges of RNA-Seq

In attempting to achieve these goals, one still faces enormous computational and statistical challenges.

Sequence-based transcriptomic data (“RNA-Seq”) can be fundamentally complex. (a) genes can be expressed with widely varying copy numbers that change rapidly, (b) the same gene can have multiple splice variants whose structures can remain unannotated, and can be expressed in unknown and varying proportions, and (c) many genes can belong to gene-families that can share high-degree of homology. (See, e.g., References 2, 4, 6, 7, 8 and 22).

Short read sequencing technologies (e.g., Illumina HiSeq, etc.) have limitations. Base-calling errors tend to be rather high for next generation sequencing platforms (e.g., more than about 1% error in the initial 100 bp read, with the error rate rising further with the read-length), which further confounds the analysis of already complex transcriptomic data. (See, e.g., Reference 9).

Single-cell RNA-Seq presents additional hurdles. The data quality can be lowered by the need for enzymatic pre-amplification. This exemplary process can significantly truncate the 5′ region of the transcript, resulting in an unavoidable loss of sequence information.

Secondly, due to the small amount mRNA present in a single cell at any one time, the number of obtainable reads per cell can be much smaller than that obtainable from bulk samples (e.g., typically <40 million vs. 150 million+), making rare transcripts harder to detect. (See, e.g., References 1, 7, 8, 15 and 21).

Existing sequence analysis technologies fail to adequately address these problems (see, e.g., References 5, 12, 23, 24 and 26), which can significantly limit the effectiveness of single cell RNA-Seq. A superior base-calling approach can alleviate the situation considerably.

For example, by correctly re-calling “poor quality” bases can effectively “salvage” extra reads that would have been discarded due to low quality. This can increase the number of reads per run in cases where the sample can be of limited quantity (e.g., single cells) or can be degraded (e.g., preserved tissue).

### Exemplary Base-Calling Procedures

TotalReCaller (“TRC”) (see, e.g., Reference 17) is a rapid base-calling and resequencing platform for next-generation sequencing (“NGS”), created to be versatile in handling various genomics applications. Currently, alternative re-sequencing approaches use multiple modules serially to interpret raw sequencing data from NGS platforms, while remaining oblivious to the genomic information until the final alignment step. (See, e.g., References 3, 5, 12, 17, 23, 24 and 26). Such exemplary approaches can fail to exploit the full information from both raw sequencing data, and the reference genome, that can yield better quality sequence reads, SNP-calls, variant detection, as well as an alignment at the best possible location in the reference genome. TRC addressed this unmet need for novel reference-guided bioinformatics procedures for interpreting raw analog signals representing sequences of the bases (e.g., A, C, G, T), while simultaneously aligning possible sequence reads to a source reference genome.

The exemplary resulting base-calling procedure, TRC, achieved demonstrably improved performance in all genomic domains, wherever it has been tested. Information from the resequencing platform can be used for reading fragments of transcriptomes. The information can either be in an analog form, or can be in a digital form (e.g., a digital form of the analog output). A linear error model for the raw intensity data, coupled with Burrows-Wheeler transform (“BWT”) and FM-index based alignment create a Bayesian score function, which can then be globally optimized over all possible genomic locations using an efficient branch-and-bound approach. The exemplary system, method and computer-accessible medium according to an exemplary embodiment of the present disclosure can be implemented in software and hardware (e.g., field-programmable gate array (“FPGA”)) to achieve real-time performance.

Empirical results on real high-throughput Illumina data were used to evaluate TotalReCaller's performance relative to its peers Bustard, BayesCall, Ibis and Rolexa based on several criteria, particularly those important in clinical and scientific applications. (See, e.g., Reference 17). For example, it has been evaluated for (i) its base-calling speed and throughput, (ii) its read accuracy, (iii) its specificity and sensitivity in variant calling and (iv) its effect on FRC (“Feature-Response Curve”) analysis, as used in genome assembly. (See, e.g., Reference 18).

If the genomic and transcriptomic knowledge was complete and correct (e.g., there are high quality references genomes along with their complete annotations), then the existing TotalReCaller can derive and use a Bayesian prior efficiently to achieve similar order of high accuracy also in RNASeq applications as in its genomic version. (See, e.g., Reference 17). However, more than 50% of the RNA sequences can be estimated to be unannotated (see, e.g., References 4, 7 and 22), and complicating the matter, not only can be many genes be expressed in multiple splice-variant isoforms (e.g., whose structures can be unknown), but also in cancer, pseudo-genes can often be transcribed. These structural variations can be learned and encoded in the prior used by the exemplary system, method, and computer-accessible medium RNASeqTRC (e.g., RNASeqTRC) while facilitating self-index to carry out rapid searches.

Two important modifications—one in alignment and the other in data-structures—can play an important role in achieving this exemplary goal, and are described below. For example, below are descriptions of branch-and-bound for “gappy” alignment (e.g., to reference genome), and a compressed “stringomics” data structure that can generalize BWT to a family of strings (e.g., isoforms). The specific exemplary attributes of the exemplary RNASeqTRC that make it beneficial for single cell transcriptomic profiling are described below:

High Accuracy. RNASeqTRC's empirical Bayesian approach can yield high specificity and sensitivity.

Robustness Against Incomplete Information. Encoding the priors by “gappy” references and Stringomics data-structures can facilitate the exemplary RNASeqTRC to deal with the uncertainty of unannotated genes with no significant loss of performance (e.g., compressibility and fast queries).

High Speed. The exemplary RNASeqTRC's simplicity of structure can make it amenable to hardware acceleration.

### Exemplary Approach

An exemplary approach to transcriptomic assays follows protocols categorized into one or more of the following classes: (1) Align-then-assemble, (2) Assemble-then-align and (3) a Hybrid Approach. (See, e.g., Reference 16). Since TRC can perform simultaneous base-calling and alignment, even when it can be used in the de novo fashion, it possesses a significant amount of information about the alignments, although this information can vary from transcript-to-transcript. These variations can depend on whether the transcript has been annotated or not, and for unannotated transcript, whether it can be inferred from the reference by a “gappy” alignment.

Exemplary Base-Calling without a Reference

A base calling process at the core of TRC can involve certain selected pre-processing steps, and can vary from technology to technology. For Illumina's HiSeq technology, linear models have been developed addressing crosstalk, fading and cycle synchronous leading and lagging. (See, e.g., Reference 17). It uses a dynamic transition matrix in order to filter the raw intensity channels. The exemplary model can be derived from modeling crosstalk and fading, and can then extended to include leading and lagging. (See, e.g., Reference 17).

For simplicity, it can be assumed that in each cycle, the sequencing can proceed with one new base at a time (e.g., no lagging in a cycle asynchronous manner). In other words, after the first cycle, there can be, for example, four possible sequences of length one. After two cycles, there can be 16 possible sequences each of length two. After k-cycles, there can be 4^{k} possible sequences each of length k, and so on, which can be represented in a quaternary tree of depth k. Among these exponentially many possibilities, a small subset (e.g., ideally one unique string represented by a path in the tree) can be desired to be identified as the ones very likely to be the correct (e.g., or closest-to-the-correct) base-sequence of the DNA. The Branch and Bound procedure (see, e.g., Reference 13 and 14) can be an iterative procedure based on three consecutive steps. Each cycle can perform an exemplary iterative process comprising, for example:

Exemplary Branching: Explore the solution space by adding new leaves to the tree.

Exemplary Bounding: Evaluate the solution space by weighing the leaves of the tree with respect to a suitably chosen score function.

Exemplary Pruning: Constrain the solution space by pruning all but the best b const, b≧1 solutions: b can be the beam-width of the underlying exemplary beam-search procedure. When b=1, this can just be a greedy procedure. Subpaths of the resulting tree can be augmented with the computed score function, as well as a p-value, either using a known null-model for the score function or by empirical Bayes method, where the null model itself can be estimated from the data (e.g., ordering over the score functions of the best b solutions computed so far).

The exemplary system, method, and computer-accessible medium according to an exemplary embodiment of the present disclosure can compute maximum likelihood estimator (“MLE”) score functions from the precomputed linear models using calibrating data, or all the solutions computed so far, without modeling exact chemistry or optimally estimating the parameters of the underlying technology. The use of an exemplary data-driven score-function can be used for this purpose, as it can make the resulting TRC procedure technology-agnostic.

Following a pre-processing procedure, it can be assumed that an exemplary model for following conditional probabilities for the observations can be present: namely, Pₖ(X_{B}|B)=conditioned to the underlying base being B ∈ {A,T,C,G}, and it can be the probability of estimating the normalized intensity on B's channel to assume a value X_{B} in the k^{th} cycle; Pₖ(X_{B}|B)=conditioned to the underlying base being [symbol] B={A,T,C,G}\B, and it can be the probability of estimating the normalized intensity on B's channel to assume a value X_{B} in the k^{th} cycle. They can be approximated as Gaussian distributions with the parameters μ_{B}, σ_{B}, μ-_{B} σ-_{B}. Thus, for example:

$${P}_{k} ( {X}_{B} \vert B ) = \frac{1}{\sqrt{2 π} {σ}_{B}} exp ( \frac{- {( {X}_{B} - {μ}_{B} )}^{2}}{2 {σ}_{b}^{2}} ) . \\ Similarly , \\ {P}_{k} ( {X}_{B} \vert B ) = \frac{1}{\sqrt{2 π} {σ}_{B}} exp ( \frac{- {( {X}_{B} - {μ}_{B} )}^{2}}{2 {σ}_{B}^{2}} ) .$$

Combining the previous results, and computing the log likelihood, a score function can be generated, for example, as shown below:

$$\begin{matrix}{f}_{score} ( {X}_{B} ; k ) = ln ( \frac{{P}_{k} ( {X}_{B} \vert B )}{{P}_{k} ( {X}_{B} \vert B )} ) \\ = ln ( \frac{{σ}_{B}}{{σ}_{B}} ) + \frac{1}{2} ( \frac{( {X}_{B} - {μ}_{B} )}{{σ}_{B}} + \frac{( {X}_{B} - {μ}_{B} )}{{σ}_{B}} ) \cdot \\ ( \frac{( {X}_{B} - {μ}_{B} )}{{σ}_{B}} - \frac{( {X}_{B} - {μ}_{B} )}{{σ}_{B}} ) .\end{matrix}$$

Exemplary Base-Calling with Gappy Alignment to a Reference Genome

While the exemplary system, method, and computer-accessible medium according to an exemplary embodiment of the present disclosure can extract as much information as possible to call each base accurately and provide b-optimal solutions (e.g., b=beam-width parameter), ordered according to their scores (e.g., or their p values or quality scores), the exemplary system, method, and computer-accessible medium it can be further improved in the presence of a Bayesian prior that can also provide the marginal probabilities Pₖ(B) and Pₖ( [symbol] B). In the absence of any prior information about the underlying biological system, the most non-informative prior can be chosen to make all Pₖ(B) equiprobable for all B ∈ {A,T,C,G}, taking the value ¼ in which case Pₖ( [symbol] B=¼)¹. The values can be modified suitably when the CG-bias for the reference genome(s) can be known, or when the di-neucleotide, tri-neucleotide biases for the reference genome can be known (e.g., from the reference genome), or when the distribution of k-mers over the genome can be known.

A solution can be derived from Markov-model of the reference genome (e.g., derived from an estimated HMM), which can be inferred from an (i) assembled reference (e.g., genotypic/haplotypic) genome(s), (ii) an assembled genome with a single reference along with all the population polymorphisms (e.g., SNPs, indels, breakpoints, structural variants), (iii) a semi-assembled reference genome with a set of un-phased contigs, or (iv) from just a collection of sequence reads (e.g., possibly error-corrected, and organized in a de Bruijn graph). A more direct solution can be devised by avoiding pre-processing altogether, and simply following a “lazy-evaluation” scheme where Pk(B) (and Pk( [symbol] B)) can be estimated in real-time by aligning the (k−1)-prefix of the sequence, analyzed and “called” so far, to all the locations in the reference genome using efficient compressed and searchable data structures (e.g., Burrows-Wheeler Transform (“BWT”) and Ferragina-Manzini (“FM”) Index (collectively “FMI”) and its variants. (See, e.g., Reference 20).

Thus, for example, an exemplary composite score function can be:

$${f}_{score} ( {X}_{B} ; k ) + {w}_{align} ( \cdot ) {f}_{score}^{*} ( B ; k , {sp}_{k} , {ep}_{k} , {sp}_{k - 1} , {ep}_{k - 1} )$$

$$with$$

$${f}_{score}^{*} ( B ; k , {sp}_{k} , {ep}_{k} , {sp}_{k - 1} , {ep}_{k - 1} ) = ln ( \frac{{P}_{k} ( B )}{{P}_{k} ( B )} ) = ln ( {ep}_{k} - {sp}_{k} + 1 ) - ln ( {ep}_{k - 1} - {sp}_{k - 1} - {ep}_{k} + {sp}_{k} ) ,$$

where the FMIs spₖ and epₖ can define the interval in the FMI-dimension corresponding to all the aligned matches in the reference for B in the kth cycle, which can translate in a very straightforward manner to the number of occurrences of the sequences in the reference at cycle k, which can be calculated by epₖ−spₖ+1. Since the equivalent value after (k−1) cycle can be epₖ₋₁−spₖ₋₁+1, the corresponding number for “non-matches” to B or matches to [symbol] B, can be the difference (e.g., epₖ₋₁−spₖ₋₁−epₖ+spₖ). An exemplary estimator can be suitably modified to a “shrinkage estimator,” for instance, one using pseudo-counts, which can also avoid various degenerate situations.

The exemplary TRC base-callers can be generalized to more general class of alignments that can include “indels,” by simply expanding the four-character alphabet from {A,T,C,G} to a six-character alphabet {A,T,C,G,l,δ}, where l can represent an insertion and δ can represent a deletion. The score function appropriate for a runs of insertion and deletion can be more complex, and can also utilize some amount of “look-ahead” before employing the “pruning” step in the exemplary branch-and-bound procedure. A simplistic way to account for the effect of a “gap” can be to introduce another operation y, which can indicate that the score function can account for a gap in the alignment by restarting a new subtree rooted at a node labeled y.

For example, in an exemplary embodiment, a new alignment can restart (e.g., anywhere in the genome: the FMIs being recalculated ab initio). In order to avoid trivial gaps, there can be an appropriate gap penalty, and the putative “gaps” can be checked (e.g., using the FMIs for substrings between the gaps) in a post-processing step. The performance of the “gappy” alignments can be improved by making sure that the alignment process can be sufficiently localized. For instance, in the case of RNASeq applications, the alignments can be limited only to ORFs, or to run several alignment processes in parallel, with each process using a set of “pools” of ORFs, where all the ORFs in the same pool can be sufficiently uncorrelated from each other.

However, once such a base-caller can be used with priors resulting in “gappy” alignment, the resulting base-calls can be expected to be superior to what can be inferred by the traditional base-callers that have been developed for RNASeq applications. But more importantly, from the base call and the “gappy” alignment (e.g., the correct one being inferred from the FMI values), the locations of exons and splice sites can also be inferred, providing an annotation for the intron-exon structure, as well as the splicing isoforms that the data represent.

Exemplary Base-Calling with Alignment to an Annotated Reference Genome: “Stringomics”

For exemplary RNASeq applications, for example, the exemplary TRC can also take advantage of the annotated portions of the reference genome by using a novel data-structure. (See, e.g., Reference 10). In this exemplary structure, the exon-intron structures, and the multiple splicing-isoforms, can be encoded efficiently such that the exemplary system, method, and computer-accessible medium, according to an exemplary embodiment of the present disclosure, (e.g., for the whole genome) can be extended and generalized easily without sacrificing space and time efficiency. Thus, such exemplary “stringomics” data-structure can support the complex topology encoded by the splice junctions connecting groups of exons, and can be represented as a directed-acyclic graph (“DAG”). Its main function can be to align the sequence seen so far as a path in the graph and provides information about the next anticipated base efficiently (e.g., in terms of indices similar to FMI). It can also be possible to outline the basic exemplary ingredients of the “stringomics” data structure as described below.

A “stringome” can be defined to be a family of strings that can be obtained by concatenation of a small number of shorter elemental strings (“stringlets”) which may, or may not, additionally share many common structures, patterns and similarities or homologies. Study of such combinatorial objects has been referred to as “stringomics.” (See, e.g., Reference 10). The exemplary stringomics approach aims to solve various procedural problems related to a special case of pattern matching on hypertext. It can be built on an underlying graph, which can be a DAG.). Further, the nodes can be assumed to be partitioned into groups, whose strings can have certain additional structures that can facilitate them to be highly compressed.

An exemplary problem can consist of or comprise k groups of variable-length strings K₁, K₂, . . . , Kₖ, providing the building blocks for the “stringomes.” The strings can be n in number, can have a total length of N characters and can be further linked in a pair-wise fashion by m links, described below. Each group Kᵢ can consist of or comprise nᵢ strings {Sᵢ₁, Sᵢ₂, . . . , Sᵢₙ_{ᵢ}}, possibly similar to each other. It can be assumed that |Sᵢⱼ|≦Sₘₐₓ and nᵢ can be bounded from above by a small constant. The indicator function, 1_{s′,s″} can be 1, if there is a link (e.g., edge) between the pair of strings (s′, s″) and 0, otherwise. It can then be, n=Σᵢ₌₁^{k}nᵢ, N=Σᵢ₌₁^{k}Σⱼ₌₁ⁿ^{ᵢ}|Sᵢⱼ|, and +m=(n₁+nₖ)+Σᵢ₌₁^{k-1}Σ_{S′∈K}_{ᵢ}Σ_{S″∈K}_{ᵢ₊₁}1_{s′,S″} Several complexity bounds can be derived in terms of the parameters Nand m, resorting subsequently to the kth order empirical entropy Hₖ(K) of the string set K=∪ᵢKᵢ when dealing with compressed data structures [20].

These exemplary groups of strings can be interconnected to form a multi-partite DAG where G=(V,E) can be defined as follows. The set V can consist of or comprise n+2 nodes, one node per string Sᵢⱼ plus two special node, designated S₀ and sₙ₊₁, which can constitute the “source” and the “sink” of the multi-partite DAG, and can contain empty strings (e.g., in order to avoid generating spurious hits). The set E can consist or comprise m edges which can link strings of adjacent groups, namely edges can have the form of S_{ij′}, S_{(i+1)j″}, where 1≦j′≦nᵢ and 1≦j″≦nᵢ₊₁. In addition, the source s₀ can be connected to all strings of group K₁, and the sink Sₙ₊₁ can be linked from all strings in Kₖ.

Exemplary questions, to be addressed, can be the following: Build an index over G in order to efficiently support two basic pattern queries:

Exemplary Counting: Given a pattern P[1,p], it can be beneficial to count the number occ of pattern occurrences in G.

Exemplary Reporting: Same as the previous query, it can be important to report the positions of these occ occurrences.

Various versions of the exemplary “Stringomics,” can be created using basic building blocks, for example, D_{K} (e.g., to keep track of the indexing), T_{K}(e.g., to organize the underlying strings and stringlets) and P_{K} (e.g., to perform 2d-range queries in an index-space).

Exemplary Theorem 1 Provided below are three exemplary implementations of the “Stringomics” ensemble of data structures, which address three different contexts of use.

Exemplary I/O-efficiency: The following exemplary implementation built upon, the String B-tree for D_{K} and for T_{K}, the external-memory Range-Tree for P_{K} uses O(N/B+(m/B)(log m/log log_{B} m)) disk pages, which can be safely assumed to be O(N/B), hence O(N log N) bits of space.

Exemplary Compressed space: The following implementation for the exemplary system, method and computer-accessible medium can built upon the FM-index for D_{K}, two Patricia tries for T_{K}, the Range-Tree for P_{K} uses N Hₖ(K)+O(N)+m log²m bits of space.

Exemplary I/O+compression: The following exemplary implementation built upon, the Geometric BWT for D_{K}, the String B-tree for T_{K}, a blocked compression scheme for the strings in K, an external-memory Range-Tree for P_{K} uses O(N+m log m) bits of space.

For various RNASeq applications of interest, for example, any suffix-array like data structure can be likely to satisfy procedural needs. However, it can be preferable to utilize a further implementation based on FM-index as can be foreseen rapidly growing needs for the technology to scale.

### Exemplary Base Calling

The exemplary RNAseqTRC procedure can work in real-time, but without the fore-knowledge of whether the underlying cDNA (e.g., being read currently) can correspond to an annotated gene (e.g., in which case the prior can be already encoded in the “Stringomics” data structure) or to an unannotated gene, pseudo-gene or a contaminant (e.g., in case the prior can be available from a possibly “gappy” alignment to the reference genome). Thus, the exemplary TRC can run, in parallel, two, or multiple branch-and-bound procedures to call bases with the two sets of priors, and compare the resulting score values at the end to decide whether the cDNA examined corresponds to an annotated or unannotated gene.

Additionally, as the exemplary TRC procedure collects a new dictionary of unannotated genes, it can compile a dictionary of isoforms of genes and pseudo-genes, along with their structural descriptions in terms of exons, introns and splicing junctions. Periodically, in a “garbage-collection-like” procedure, this dictionary can be examined serially to filter out contaminants (e.g., chimeras and sterile transcripts, pseudo-genes, etc.), leaving only the newly discovered genes, rank-ordered by their score functions, or p-values. The validated newly discovered genes can then be inserted into the existing “Stringomics” data-structure, which can involve modifying the three data-structures: (i) D_{K} (e.g., to keep track of the indexing), (ii) T_{K} (e.g., to organize the underlying strings and stringlets) and (iii) P_{K} (e.g., to perform 2d-range queries in an index-space). The frequency of this exemplary “garbage-collection” procedure can be determined as the one that can optimize the computational complexity with the “dynamization.”

Thus, the exemplary TRC procedure can be abstracted away, and hidden from the rest of the exemplary RNASeq pipeline, as it can treat the exemplary TRC as just a base-calling module—except that it has the ability to produce better-quality base-calls, and that it can be tuned suitably to take advantage of the trade-off between false-positive and negative errors.

### Exemplary Transcriptome Profiling

If the focus was only on the set of transcripts associated with the annotated genes, as would be the case in many clinical transcriptomic applications, then an exemplary strategy would be to keep track of the splice-junctions (e.g., the edges in the Stringomics graph) corresponding to the reads seen from the entire set of reads. The exemplary paths in the Stringomics data-structure induced by the edges, labeled by the tracking of splice-junctions, can correspond to the splice-variants isoforms, and a rough estimate of such paths can be inferred by a max-flow procedure running on the graph, (e.g., expression profile). However, a better estimate for the expressed transcripts and their copy number can be obtained from a Bayesian procedure that, in its prior, can model the distributions of the data that can correspond to a particular hypothesized transcriptomic profiling.

### Exemplary Transcriptome Assembly

In certain exemplary applications, in addition to transcription profiling, it can be beneficial to discover mutational changes to transcripts, transcript-editing, new transcripts, new splice-variant isoforms of known/annotated transcripts, or even sterile transcripts (e.g., resulting from pseudo-genes). For such exemplary applications, the reads can be accurately assembled, which can be complicated by the read-lengths, quality of base-calling, and various subtle statistical issues related to variable coverage, estimation of optimal parameters, strand-specificity, etc. Exemplary advantages provided by the exemplary RNASeqTRC procedure can be: (i) base-calling accuracy, (ii) longer reads and (iii) information from alignments to stringomics and reference (e.g., that can be stored by FM-indices or D_{K}/P_{K} structure in Stringomics). This additional information can provide important ingredients to check local correctness of the string-overlaps, and can be summarized by a global score function. An exemplary overlap-Layout-Consensus-based global-optimizing procedure, such as SUTTA (see, e.g., Reference 19), can be used with this information to assemble the reads, and count the coverage in each transcript-assembly, to create a transcriptional profile for all transcripts (e.g., sterile or otherwise), and to discover those assemblies that fail to match any of the known annotated transcripts, or fail to align to the reference by a “gappy” alignment.

As discussed above, the exemplary strategies for whole genome transcript-analysis can usually be categorized in terms of three related approaches: (i) Align-then-assemble, (ii) Assemble-then-align and (iii) Hybrid. (See, e.g., Reference 16). The exemplary system, method, and computer-accessible medium, according to an exemplary embodiment of the present disclosure, can be considered a hybrid approach as the underlying base-caller, TRC, and can automatically align to all the known information, such as references, annotations and variations (e.g., provided in its prior), and use this information in base-calling, assembly, validation and discovery.

### Additional Exemplary Embodiments

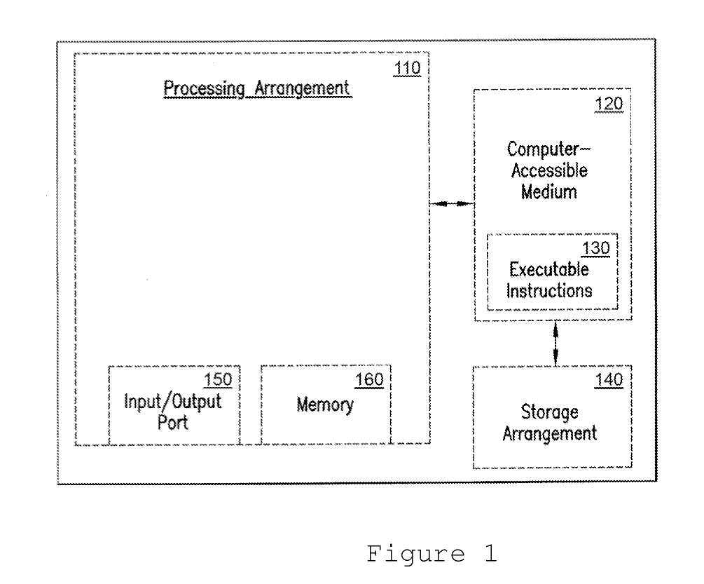

FIG. 1 shows an exemplary block diagram of an exemplary embodiment of a system according to the present disclosure. For example, any exemplary method or procedure in accordance with the present disclosure described herein can be performed by a processing arrangement 110 and/or a computing arrangement 110. Such processing/computing arrangement 110 can be, for example, entirely or a part of, or include, but not limited to, a computer/processor that can include, for example, one or more microprocessors, and use instructions stored on a computer-accessible medium (e.g., RAM, ROM, hard drive, or other storage device).

As shown in FIG. 1, for example, a computer-accessible medium 120 (e.g., as described herein, a storage device such as a hard disk, floppy disk, memory stick, CD-ROM, RAM, ROM, etc., or a collection thereof) can be provided (e.g., in communication with the processing arrangement 110). The computer-accessible medium 120 can be a non-transitory computer readable storage medium, and can contain executable instructions 130 thereon, wherein the instructions are executable on a computer processor or other processing arrangement 110 to perform any of the exemplary methods and processes described herein. In addition or alternatively, a storage arrangement 140 can be provided separately from the computer-accessible medium 120, which can provide the instructions to the processing arrangement 110 so as to configure the processing arrangement to execute certain exemplary procedures, processes and methods, as described herein, for example.

Further, the exemplary processing arrangement 110 can be provided with or include an input/output arrangement 150, which can include, for example, a wired network, a wireless network, the internet, an intranet, a data collection probe, a sensor, etc. As shown in FIG. 1, the exemplary processing arrangement (e.g., computing arrangement, which can include one or more computers) 110 can further be provided with and/or include exemplary memory 160, which can be, for example, cache, RAM, ROM, flash memory, etc. Further, the exemplary processing arrangement (e.g., computing arrangement, which can include one or more computers) 110 can be in communication with an exemplary display arrangement which, according to certain exemplary embodiments of the present disclosure, can be a touch-screen configured for inputting information to the processing arrangement in addition to outputting information from the processing arrangement, for example. Further, the exemplary display and/or storage arrangement 140 can be used to display and/or store data in a user-accessible format and/or user-readable format. The exemplary processing/computing arrangement 110 shown in FIG. 1 can execute the exemplary procedures described herein, as well as those shown in the drawings.

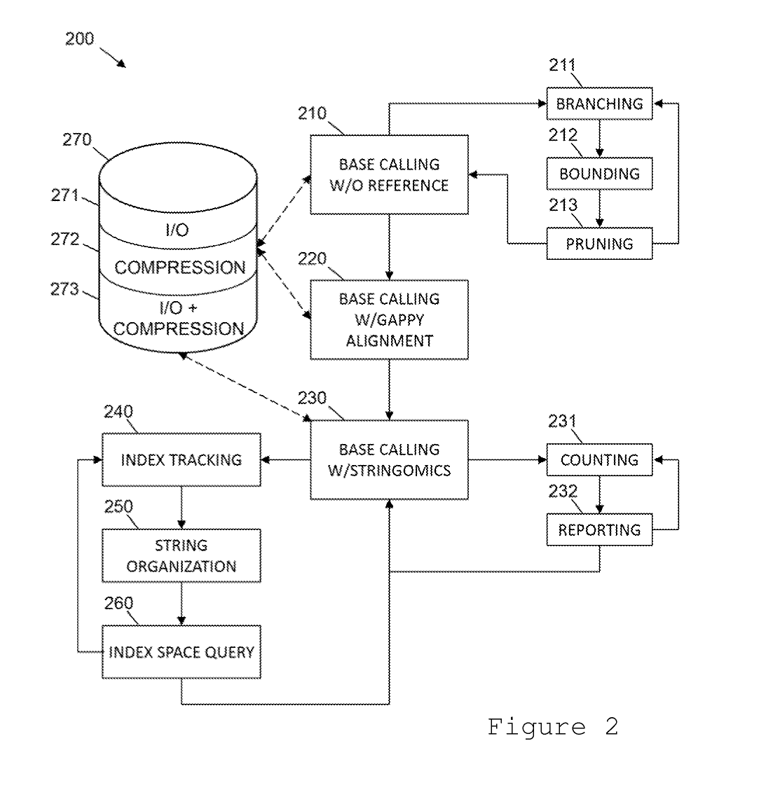

FIG. 2 shows an exemplary block diagram of a combination of an exemplary system, process and/or method 200 for base calling and mapping, according to an exemplary embodiment of the present disclosure. For example, the exemplary processes or methods described above can be performed by a processing or computing arrangement as described herein, or by another computer system executing code stored on a non-transitory computer-readable data storage medium, where the computer system includes a processor that executes code blocks to perform the exemplary process or method. In various examples and embodiments, improvements to the exemplary TRC systems and procedures described herein can be utilized, for example by execution on one or more of the exemplary processing or computing arrangements, in order to perform one or more of these exemplary processes or methods, according to the present disclosure.

In these various examples and embodiments, systems and methods of transcriptomic assays can be executed according to one or more protocols including, but not limited to, align-then-assemble, assemble-then-align, and/or a hybrid approach. These exemplary protocols can include substantially simultaneous base calling and alignment, in a de novo fashion, where alignment information can vary from transcript to transcript. The variations can depend, for example, upon whether a given transcript can be annotated, and whether a given unannotated transcript can be inferred from reference by a gappy alignment, as described above.

Various building blocks, procedures, method procedures and/or programming modules can be utilized. These can include, but are not limited to, base calling without reference (e.g., procedure, block or module 210), base calling with gappy alignment to a reference genome (e.g., procedure, block or module 220), and/or base calling with alignment to an annotated reference genome or “stringomics” (e.g., procedure, block or module 230).

Base calling without reference (e.g., procedure, block or module 210) can include pre-processing procedures and linear modeling to address crosstalk, fading and cycle synchronous lagging derived from modeling crosstalk and fading, and extended to include leading or lagging. An exemplary dynamic transition matrix can be used to filter the raw intensity channels.

In each exemplary cycle, sequencing can proceed with one new base at a time (e.g., with no asynchronous lagging). After k-cycles, for example, there can be 4k possible sequences, each of length k, which can be represented in a quaternary tree of depth k. Among these exemplary possibilities, a subset (e.g., one or more unique strings represented by one or more paths in the tree) can be identified as correct, likely to be correct or closest-to-correct base-sequence of the DNA.

An exemplary branch and bound procedure can be utilized, which can employ an iterative procedure based on consecutive procedures in which each cycle can perform an iterative process. The iterative process can comprise one or more of branching (e.g., procedure, process, block or module 211) to explore the solution space by adding new leaves to the tree, bounding (e.g., procedure, process, block or module 212) to evaluate the solution space by weighing the leaves of the tree with respect to a suitably chosen score function, as described above, and pruning (e.g., procedure, process, block or module 213) to constrain the solution space by pruning all but selected solutions, for example based on beam width of the underlying beam search procedure as described above. Subpaths of the resulting tree can be augmented with the score function and/or a p-value using a null-model or by empirical Bayesian methods.

An exemplary maximum likelihood estimator score function can be computed from the precomputed linear models using calibration data, for example, using a data-driven score-function without modeling exact chemistry or estimating underlying technology parameters. Following pre-processing, an exemplary model can be defined for conditional observation probabilities, for example as conditioned to the underlying base and approximated by Gaussian distributions.

In the exemplary base calling with gappy alignment (e.g., procedure, block or module 220), a selected score function can be utilized to extract information, and accurately call or identify each base (e.g., in the sequence), and provide a beam width parameter to prune solutions ordered according to score or p-value, for example utilizing an exemplary Bayesian prior. The exemplary prior can be chosen based on equal probability, and values can be modified in a suitable fashion when the CG-bias for the reference genome(s) can be known or when the di-neucleotide, tri-neucleotide biases for the reference genome can be known, or when the distribution of k-mers over the genome can be known.

A further exemplary solution can be derived from a Markov model of the reference genome, which can be identified or inferred from (i) an assembled reference, (ii) an assembled genome with a single reference along with the population polymorphisms, (iii) a semi-assembled reference genome with a set of un-phased contigs, or (iv) a collection of sequence reads. Other exemplary solutions can be provided by omitting preprocessing and following a procedure where probabilities can be estimated in real time by prefix alignment.

Suitable composite score functions are described above. The exemplary base calling procedure can also be generalized to classes of alignments that can include “indels,” for example, by expanding the four-character alphabet {A,T,C,G} to a six-character alphabet {A,T,C,G,l,δ}, where l can represent an insertion and δ can represent a deletion. Exemplary score functions for runs of insertion and deletion can be more complex, and can employ look-ahead before the pruning procedure in the branch-and-bound procedure. Another exemplary operation y can be used to indicate that the score function can account for a gap in the alignment, for example, by restarting a new subtree rooted at a labeled node.

The exemplary system, method, and computer-accessible medium, according to an exemplary embodiment of the present disclosure, can facilitate a new alignment to restart anywhere in the genome. To avoid trivial gaps, an exemplary gap penalty can be utilized, and putative gaps can be checked using FM indices for substrings between the gaps in post processing. The exemplary gappy alignment performance can be improved by localizing the alignment process, for example, by limiting the alignments to ORFs, by running a plurality of alignment processes in parallel, or with each process, using a set of “pools” of ORFs, where the ORFs in a given (e.g., same) pool can be substantially uncorrelated. When a base caller is used with priors resulting in gappy alignment, the resulting base calls can be superior to what can be inferred by traditional procedures developed for RNASeq applications. In addition, the locations of exons and splice sites can also be inferred, or determined, from the base call and “gappy” alignment, providing an annotation for the intron-exon structure, as well as splicing isoforms that the data can represent.

In base calling with alignment to an annotated reference genome or “Stringomics” (e.g., procedure, block or module 230), an exemplary data structure can be utilized for annotated portions of the reference genome, where exon-intron structures and/or multiple splicing-isoforms can be encoded such that the procedure for the genome can be extended and generalized while maintaining space and time efficiency. The stringomics data structure can support complex topology encoded by the splice junctions connecting groups of exons, and can be represented as a DAG. The structure can function to align the sequence, and to provide information about the next anticipated base.

The exemplary system, method and computer-accessible medium, according to an exemplary embodiment of the present disclosure, can define stringomes by concatenation of shorter elemental strings or stringlets, as described above, which can share common structures, patterns, similarities or homologies, in order to address cases of pattern matching on hypertext. The underlying exemplary graph can be directed and acyclic, and nodes can be partitioned into groups whose strings can have additional structures that facilitate compression.

The exemplary groups of strings can be interconnected to form a multi-partite DAG, for example, with one or more sets V of designated nodes and sets E of edges. The exemplary system, method, and computer-accessible medium, according to an exemplary embodiment of the present disclosure, can build an index to support pattern queries including, but not limited to, counting (e.g., procedure or process 231) the number of pattern occurrences, and reporting (e.g., procedure or process 232) the posigions of the occurrences. Additional building blocks or program modules can also be utilized, including, but not limited to, index tracking (e.g., D_{K}; procedure, block or module 240), string organization (e.g., T_{K}; procedure, block or module 250), and index space querying (e.g., P_{K}; procedure, block or module 260).

A database, storage arrangement 140 of FIG. 1 or other memory 270 of FIG. 2 can be utilized with one or more stringomics data structures. Depending on application or context of use, as illustrated in FIG. 2, the data structures can include one or more of an I/O-efficiency data structure or implementation 271, for example, built on a string B-tree, a compressed space data structure or implementation 272, for example, built upon an FM-index, and an I/O+compression data structure or implementation 273, for example, built upon a Burrows-Wheeler transform, each as described above. Alternatively, any suitable suffix-array-like data structure can be utilized. Nonetheless, a somewhat more complex implementation based on the FM-index can be preferred in order to scale the technology.

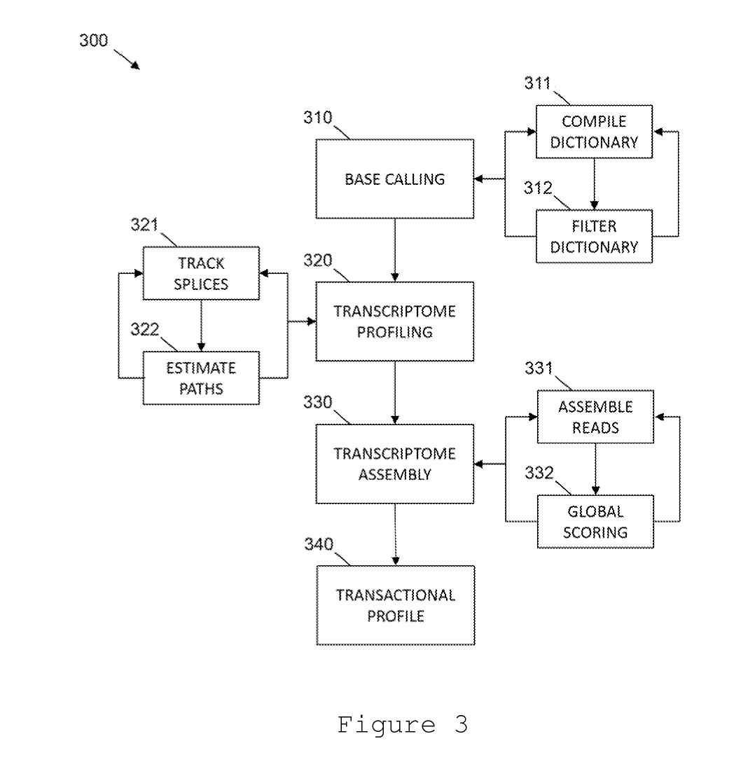

FIG. 3 shows an exemplary block diagram of another exemplary method 300 for generating a transactional profile in accordance with an exemplary embodiment of the present disclosure. In this example, the method 300 of RNA sequencing can include one or more procedures including, but not limited to, base calling (e.g., procedure 310), transcriptome profile (e.g., procedure 320), and transcriptome assembly (e.g., procedure 330), each as described above.

For the exemplary base calling (e.g., procedure 310), the exemplary sequencing procedure can operate in real time, whether the underlying cDNA read can correspond to an annotated gene or an unannotated gene. A plurality of branch-and-bound procedure can operate in parallel to call bases with different sets of priors, comparing the resulting score values to determine whether the examined cDNA can correspond to an annotated or unannotated gene. Dictionaries of isoforms of genes and pseudo-genes can be compiled (e.g., procedure 311), along with associated structural descriptions in terms of exons, introns, and splicing junctions. The dictionary can be examined serially to filter out contaminants such as chimera, sterile transcripts, pseudo-genes, etc. (e.g., procedure 312), leaving only newly discovered genes, for example rank-ordered by their corresponding score functions or p-values, and/or inserted into an existing stringomics data structure.

In transcriptome profiling (e.g., procedure 320), splice junctions (e.g., edges in the

Stringomics graph) can be recorded (e.g., procedure 321). Exemplary paths in the Stringomics data structures induced by the edges labeled by tracking the splice junctions can correspond to splice-variant isoforms, and such paths can be estimated (e.g., procedure 322), for example, by a max-flow procedure running on the graph. Alternatively, or in addition, an estimate for the expressed transcripts and their copy number can be obtained from a Bayesian procedure, as described above.

In the exemplary transcriptome assembly (e.g., procedure 330), for example, reads can be accurately assembled (e.g., procedure 331), for example, by incorporating read-lengths, quality of base calling and statistical issues. Advantages can include, but are not limited to, (i) improved base-calling accuracy, (ii) longer reads, and (iii) additional information from alignments to stringomics, which can be summarized by a global score function (e.g., procedure 332). Assembling the reads (e.g., procedure 331) can include counting the coverage in each transcript-assembly, for example to create a transcriptional profile (e.g., procedure 340) for any or all transcripts, sterile or otherwise, and/or to discover or identify assemblies that fail to match any known annotated transcripts, or which fail to align to the reference by gappy alignment.

### Exemplary Conclusion

Exemplary embodiments of the present disclosure provides systems, methods, apparatus and computer-readable medium which facilitates a transcriptional analysis using very accurate and efficient procedures that can be implemented in hardware to run in real-time. The exemplary systems, methods, apparatus and computer-readable medium can efficiently use Bayesian priors to improve accuracy, and since it obtains these priors from the reference genome and its annotations, it can be classified to be a “reference-based strategy.” The success of reference-based assemblers can depend on the quality of the reference genome being used. Since TRC can optimize the w_{align} parameter in its score function, TRC can trade off errors (e.g., false positives and negatives) in the best possible manner. TRC would likely not be affected in a significant manner by the hundreds to thousands of mis-assemblies and large genomic deletions, which can lead to misassembled or partially assembled transcriptomes, which exist in many extant reference assemblies. (See e.g., Reference 16).

Another issue can arise from certain trans-spliced genes, in which two pre-mRNAs can be spliced together into a single mature mRNA, and benefits from TRC's stringomics data structure's flexibility in subsuming additional complexities. In the exemplary description provided here, such trans-spliced genes (e.g., or those with RNA-editing) can show up as uninterpretable new transcripts and their status as new discoveries, as chimeras or as contaminants may have to be classified in a post-processing procedure.

The exemplary embodiments of the present disclosure further address the absence of an efficient and reliable procedure implementing hybrid assembly strategy for short-read transcripts. Martin and Wang wrote [16], recently, “To date, there may be no automated software pipelines that can carry out the hybrid assembly strategy. A systematic analysis can explore which errors can be introduced by hybrid assembly approaches. In the align-then-assemble approach, methods can be provided to detect the errors in the reference assemblies, in order to prevent them from being propagated into the final assembly. In the exemplary assemble-then-align approach, measures must be taken to avoid incorrectly joining segments of different genes (e.g., chimeras).” It can be likely that the exemplary approach can address these short-comings.

The foregoing merely illustrates the principles of the invention. Various modifications and alterations to the described embodiments will be apparent to those skilled in the art in view of the teachings herein. It will thus be appreciated that those skilled in the art will be able to devise numerous systems, arrangements, and methods which, although not explicitly shown or described herein, embody the principles of the invention and are thus within the spirit and scope of the invention. In addition, all publications and references referred to herein are hereby incorporated herein by reference in their entireties. It should be understood that the exemplary procedures described herein can be stored on any computer-accessible medium, including, for example, a hard drive, RAM, ROM, removable discs, CD-ROM, memory sticks, etc., included in, for example, a stationary, mobile, cloud or virtual type of system, and executed by, for example, a processing arrangement which can be or include one or more hardware processors, including, for example, a microprocessor, mini, macro, mainframe, etc.

### EXEMPLARY REFERENCES

The following references are hereby incorporated by reference in their entirety.
[1] T. Bartfai, P. Buckley, and J. Eberwine. Drug targets: single-cell transcriptomics hastens unbiased discovery. Trends in Pharmacological Sciences, 33(1):9-16, 2012.
[2] P. Batut, A. Dobin et al. High-fidelity promoter profiling reveals widespread alternative promoter usage and transposon-driven developmental gene expression. Genome Research, 23(1):169-180, 2013.
[3] F. D. Bona, S. Ossowski et al. Optimal spliced alignments of short sequence reads. Bioinformatics, 24(16):1174-1180, 2008.
[4] S. Djebali, C. Davis et al. Landscape of transcription in human cells. Nature, 489(7414):101-108, 2012.
[5] A. Dobin, C. Davis et al. Star: ultrafast universal rna-seq aligner. Bioinformatics, 29(1):15-21, 2013.
[6] I. Dunham, A. Kundaje et al. An integrated encyclopedia of dna elements in the human genome. Nature, 489(7414):57-74, 2012.
[7] J. Eberwine, P. Buckley et al. Role of cytoplasmic splicing in modulating cellular function. Alcoholism-Clinical and Experimental Research, 36:343A, 2012.
[8] J. Eberwine, D. Lovatt et al. Quantitative biology of single neurons. Journal of the Royal Society Interface, 9(77):3165-3183, 2012.
[9] Y. Erlich, P. Mitra et al. Alta-cyclic: a self-optimizing base caller for next-generation sequencing. Nature Methods, 5(8):679-682, 2008.
[10] P. Ferragina and B. Mishra. Pattern matching against “stringomes”. page l 1pp, 2013, which is incorporated by reference herein, in the entirety and for all purposes.
[11] T. Gingeras. Implications of chimaeric non-co-linear transcripts. Nature, 461(7261):206-211, 2009.
[12] G. Grant, M. Farkas et al. Comparative analysis of rna-seq alignment algorithms and the rna-seq unified mapper (rum). Bioinformatics, 27(18):2518-2528, 2011.
[13] A. Land and A. Doig. An automatic method of solving discrete programming problems. Econometrica: Journal of the Econometric Society, 28(3):497-520, 1960.
[14] E. Lawler and D. Wood. Branch-and-bound methods: A survey. operations research. 14(4):699-719, 1966.
[15] J. Levsky, S. Shenoy et al. Single-cell gene expression profiling. Science, 297(5582):836-840, 2002.
[16] J. Martin and Z. Wang. Next-generation transcriptome assembly. Nature Reviews Genetics, 12:671-682, 2011.
[17] F. Menges, G. Narzisi, and B. Mishra. Totalrecaller: improved accuracy and performance via integrated alignment and base-calling. Bioinformatics, 27(17):2330-2337, 2011, which is incorporated by reference herein, in the entirety and for all purposes.
[18] B. Mishra. The genome question: Moore vs. jevons. Computer Society of India: Journal of Computing, 2012, which is incorporated by reference herein, in the entirety and for all purposes.
[19] G. Narzisi and B. Mishra. Scoring-and-unfolding trimmed tree assembler: Concepts, constructs and comparisons. Bioinformatics, 27(12):153-160, 2011, which is incorporated by reference herein, in the entirety and for all purposes.
[20] G. Navarro and V. Mäkinen. Compressed full-text indexes. ACM Computing Surveys, 39(1), 2007.
[21] M. Tariq, H. Kim et al. Whole-transcriptome rnaseq analysis from minute amount of total rna. Nucleic Acids Research, 39(18), 2011.
[22] H. Tilgner, D. Knowles et al. Deep sequencing of subcellular rna fractions shows splicing to be predominantly co-transcriptional in the human genome but inefficient for incrnas. Genome Research, 22(9):1616-1625, 2012.
[23] C. Trapnell, L. Pachter, and S. Salzberg. Tophat: discovering splice junctions with rna-seq. Bioinformatics, 25(9):1105-1111, 2009.
[24] K. Wang, D. Singh et al. Mapsplice: Accurate mapping of rna-seq reads for splice junction discovery. Nucleic Acids Research, 38(18), 2010.
[25] M. Wigler. Broad applications of single-cell nucleic acid analysis in biomedical research. Genome Medicine, 4(10), 2012.
[26] T. Wu and S. Nacu. Fast and snp-tolerant detection of complex variants and splicing in short reads. Bioinformatics, 26(7):873-881, 2010.

What is claimed is:

1. A non-transitory computer-accessible medium having stored thereon computer-executable instructions for generating at least one transcriptome profile and at least one transcriptome assembly of at least one patient, wherein, when a computer arrangement executes the instructions, the computer arrangement is configured to perform procedures comprising:
receiving first information related to an analog output from a sequencing platform configured to be used for reading a fragment of at least one transcriptome;
generating second information related to a base calling of the first information; and
generating the at least one transcriptome profile and the at least one transcriptome assembly based on the second information.

2. The computer-accessible medium of claim 1, wherein the base calling includes at least one of (i) a base calling without reference, (ii) a base calling with a gappy alignment to a reference genome, or (iii) a base calling with alignment to an annotated reference transcriptome.

3. The computer-accessible medium of claim 1, wherein the computer arrangement is further configured to generate the second information without knowledge of whether at least one complimentary deoxyribonucleic acid (cDNA) corresponds to at least one of (i) at least one annotated gene, (ii) at least one unannotated gene, (iii) at least one pseudo gene, or (iv) at least one contaminant.

4. The computer-accessible medium of claim 1, wherein the computer arrangement is further configured to determine third information related to whether at least one complimentary deoxyribonucleic acid (cDNA) is at least one of an annotated or an unannotated gene.

5. The computer-accessible medium of claim 4, wherein the computer arrangement is further configured to determine the third information using multiple branch-and-bound procedures.

6. The computer-accessible medium of claim 5, wherein the branch-and-bound procedures are performed by the computer arrangement substantially in parallel with one another.

7. The computer-accessible medium of claim 5, wherein each brand-and-bound procedure of the branch-and-bound procedures is configured to call bases with at least two sets of priors.

8. The computer-accessible medium of claim 4, wherein the computer arrangement is further configured to generate a dictionary of a plurality of unannotated genes including at least one of (i) isoforms of genes, (ii) isoform of pseudo-genes, (iii) structural descriptions of exons, (iv) structural descriptions of introns, or (v) splicing junctions.

9. The computer-accessible medium of claim 8, wherein the computer arrangement is further configured to filter out contaminants from the dictionary.

10. The computer-accessible medium of claim 1, wherein the computer arrangement is further configured to generate the at least one transcriptome profile based on a Bayesian procedure.

11. The computer-accessible medium of claim 10, wherein the Bayesian procedure models a distribution of data corresponding to a particular hypothesized transcriptome profile.

12. The computer-accessible medium of claim 1, wherein the at least one transcriptome assembly includes at least one of (i) mutational changes to transcripts, (ii) transcript editing, (iii) new transcripts, (iv) new splice-variant isoforms of known and unknown transcripts, or (v) sterile transcripts.

13. The computer-accessible medium of claim 1, wherein the at least one transcriptome assembly is based on at least one pseudo-gene.

14. The computer-accessible medium of claim 1, wherein the computer arrangement is further configured to generate the at least one transcriptome assembly based on an overlap-layout-consensus-based global-optimizing procedure.

15. The computer-accessible medium of claim 14, wherein overlap-layout-consensus-based global-optimizing procedure is configured to assemble reads.

16. The computer-accessible medium of claim 14, wherein overlap-layout-consensus-based global-optimizing procedure configures the computer arrangement to determine particular assemblies that at least one of (i) fail to match known annotated transcripts, or (ii) fail to align to a reference by a gappy alignment.

17. The computer-accessible medium of claim 1, wherein the computer arrangement is further configured to generate third information related to at least one patient based on the least one transcriptome profile and the at least one transcriptome assembly.

18. The computer-accessible medium of claim 17, wherein the third information includes at least one of (i) a disease of the at least one patient, (ii) a disease state of a disease of the at least one patient, or (iii) a therapy to be applied to the at least one patient.

19. A system for generating at least one transcriptome profile and at least one transcriptome assembly of at least one patient, comprising:
a computer hardware arrangement configured to:
receive first information related to an analog output from a sequencing platform configured to be used for reading a fragment of at least one transcriptome;
generate second information related to a base calling of the first information; and
generate the at least one transcriptome profile and the at least one transcriptome assembly based on the second information.

20. A method for generating at least one transcriptome profile and at least one transcriptome assembly of at least one patient, comprising:
receiving first information related to an analog output from a sequencing platform configured to be used for reading a fragment of at least one transcriptome;
generating second information related to a base calling of the first information; and
using a computer hardware arrangement, generating the at least one transcriptome profile and the at least one transcriptome assembly based on the second information.
